(19) United States
(12) Patent Application Publication
(10) Pub. No.: US 2026/0179577 A1
(43) Pub. Date: Jun. 25, 2026

(54) METHOD FOR MODULATING LIQUID CRYSTAL DISPLAY AND CIRCUIT SYSTEM

(71) Applicant: REALTEK SEMICONDUCTOR CORP., HSINCHU (TW)

(72) Inventor: CHENG-CHUN WANG, HSINCHU (TW)

(21) Appl. No.: 19/428,548

(22) Filed: Dec. 22, 2025

(30) Foreign Application Priority Data
Dec. 25, 2024 (TW) 113150536

(51) Int. Cl. G09G 3/34; G09G 3/36

(52) U.S. Cl. CPC G09G 3/3406; G09G 3/36; G09G 2320/0626; G09G 2320/066; G09G 2320/0686; G09G 2330/021

(57) ABSTRACT

A method for modulating a liquid crystal display and a circuit system. In the method, the circuit system receives image data from an image source, and each of the frames of the image data is divided into multiple blocks. After the image data is frame-by-frame analyzed, a maximum brightness and an average brightness of each of pixels of the blocks are obtained. Accordingly, a target backlight value of a backlight module can be determined and a control signal is generated for driving each of the blocks of the backlight module to illuminate according to the target backlight value. A set of code values for a display panel can be obtained according to a target brightness set by the circuit system and the target backlight value, so that the code values for reaching the target brightness corresponding to every pixel in the block can be determined.

### CROSS-REFERENCE TO RELATED PATENT APPLICATION

This application claims the benefit of priority to Taiwan Patent Application No. 113150536, filed on December 25, 2024. The entire content of the above identified application is incorporated herein by reference.

Some references, which may include patents, patent applications and various publications, may be cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference was individually incorporated by reference.

### FIELD OF THE DISCLOSURE

The present disclosure relates to a technology of modulating a display, and more particularly to a method and a circuit system for modulating a liquid crystal display by compensating code values for a display panel so as to save power of a backlight module.

### BACKGROUND OF THE DISCLOSURE

The largest system power consumer of a traditional liquid crystal display (LCD) is its backlight. The power consumption of the LCD can be measured in different backlight intensities and light-transmittance parameters, and adjustment of the backlight intensities and the light-transmittance parameters can be expressed by normalization of pulse-width modulation (PWM). For example, the adjustment of the light-transmittance parameters is such as adjusting angles of liquid crystals for controlling a light-transmittance rate, namely code values. The backlight is brightest when the value of pulse-width modulation of backlight is normalized to “1.” When the measured value shows that the backlight is fully on, the power consumption does not change much in different code values. On the contrary, the backlight has a highest light-transmittance rate when angles of the liquid crystals are fully on due to a fully-on code value. Further, the power consumption of the backlight occupies an extremely high proportion of the power consumption of a display system if the intensity of the backlight is adjusted from a lowest value to a highest value. Accordingly, this shows that, when the brightness of the LCD is adjusted, the power consumption of the backlight is much greater than the power consumption of an LC panel.

Conventional backlight dimming is categorized into global dimming and local dimming. Both the conventional global dimming method and local dimming method can achieve a purpose of power saving when turning down the intensity of the backlight. However, the lower backlight intensity will cause displayed images to be darker and reduce image quality.

Reference is made to FIG. 1, which shows a display principle of an LCD. An LCD 10 shown in the diagram mainly includes a backlight module 101 and an LC panel. The light-emitting elements such as LEDs or CCFLs of the backlight module 101 are driven by voltages generated by a driving circuit for generating a backlight. The LC panel includes a thin-film transistor (TFT) layer 103 that is controlled by electric signals for changing an electric field and a liquid crystal layer 105 in which the liquid crystal molecules are deflected based on the changes of the electric field. The liquid crystal layer 105 determines brightness and darkness of all pixels and allows the LCD 10 to display color images through a color filter 107. A glass panel 109 can be provided in an outermost layer of the LCD 10.

According to display principle of the LCD, the angles of liquid crystal molecules in the liquid crystal layer 105 determine the light-transmittance rate of each of the pixels when the backlight generated by the backlight module 101 passes through the liquid crystal layer 105, and also define code values. The code values indicate the light-transmittance parameters. Thus, the backlight brightness and the code value cooperatively define the brightness of each of the pixels. Therefore, it is possible that the brightness is not affected while achieving the purpose of saving power consumption of the backlight.

The current technology, such as a Vesa Display HDR technology, regulates that the code values are adjusted to match the backlight module 101 for possibly achieving the purpose of power saving without affecting the brightness. However, even though the Vesa Display HDR technology can be used to increase contrast and restore the brightness, its effect on power saving is not significant.

### SUMMARY OF THE DISCLOSURE

In response to the above-referenced technical inadequacy that the solution provided by the conventional technology for saving power consumption for a liquid crystal display (LCD) does not achieve a significant effect, provided in the present disclosure is a method for modulating a liquid crystal display and a circuit system. An algorithm operated in the circuit system of the display is used to calculate code values for compensating the brightness of a backlight for a person not seeing the difference even if the backlight brightness is reduced. Accordingly, the display can maintain or improve image quality while achieving the purpose of power saving.

In one aspect, the circuit system is electrically connected with a backlight module and a display panel of the display, the circuit system performs the method for modulating the liquid crystal display.

According to one embodiment of the method for modulating the liquid crystal display, the image data is frame-by-frame divided into multiple blocks, and frame-by-frame analyzed to obtain a maximum brightness and an average brightness of each of the blocks. Accordingly, a target backlight value of the backlight module can be determined. A first control signal used to drive each of the blocks of the backlight module to illuminate is generated according to the target backlight value for each of the blocks or a global block of the backlight module.

Next, a set of code values for the display panel can be obtained based on the target brightness set by the circuit system and the target backlight value of the backlight module. The code values corresponding to the pixels in each of the blocks for reaching the target brightness can be determined. The circuit system then generates a second control signal that is used to drive the display panel according to the code values of the pixels.

Further, the circuit system can be a circuitry disposed in a display or in a video device. The circuit system receives image data from an image source. The circuit system operates the method for modulating the liquid crystal display for outputting the first control signal and the second control signal to respectively drive the backlight module and the display panel of the display.

Further, when the backlight module of the display is a local dimming type of backlight, a quantity of the multiple blocks that are frame-by-frame divided is equal to a quantity of local regions of the backlight module; when the backlight module is a global dimming type of backlight, the image data is frame-by-frame divided into a fixed quantity of the multiple blocks.

Further, according to one embodiment, when the backlight module is a local-dimming type of backlight, a brightness value of a brightness coverage ratio of each of the blocks is used as a target to determine a brightness value of the backlight; when the backlight module is a global dimming type of backlight, a brightness value of an average brightness coverage ratio of a fixed quantity of blocks is used as the target to determine the brightness value of the backlight.

Still further, when the code values for the display panel are determined, a light spread modeling method is introduced to calculate a brightness value of each of the pixels in each of the blocks corresponding to the backlight brightness value according to the target backlight value, and to obtain a backlight brightness distribution of each of the blocks in each of the frames.

Further, the code values of the pixels in each of the blocks for reaching an overall target brightness can be determined according to the overall target brightness and the backlight brightness distribution.

Further, a Sigmoid function is introduced to process the code value corresponding to each of the pixels and increase image contrast by adjusting an S-curve of the code value in blocks.

These and other aspects of the present disclosure will become apparent from the following description of the embodiment taken in conjunction with the following drawings and their captions, although variations and modifications therein may be affected without departing from the spirit and scope of the novel concepts of the disclosure.

### BRIEF DESCRIPTION OF THE DRAWINGS

The described embodiments may be better understood by reference to the following description and the accompanying drawings, in which:

FIG. 1 is a schematic diagram illustrating main components of a conventional liquid crystal display;

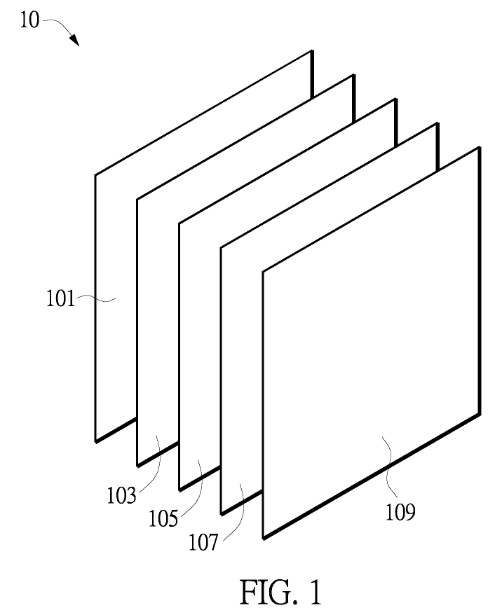

FIG. 2 is a schematic diagram illustrating a system framework of the circuit system for performing the method for modulating the liquid crystal display according to one embodiment of the present disclosure;

FIG. 3 is a flowchart illustrating the method for modulating the liquid crystal display according to one embodiment of the present disclosure;

FIG. 4 is a schematic diagram depicting a frame being divided into multiple blocks in one embodiment of the present disclosure; and

FIG. 5 is a schematic diagram depicting a light spread diagram established in the method for modulating the liquid crystal display according to one embodiment of the present disclosure.

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a,” “an” and “the” includes plural reference, and the meaning of “in” includes “in” and “on.” Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first,” “second” or “third” can be used to describe various components, signals or the like, which are for distinguishing one component/signal from another one only, and are not intended to, nor should be construed to impose any substantive limitations on the components, signals or the like.

The present disclosure relates to a method for modulating a liquid crystal display (LCD) and a circuit system. One of the objectives of the method is to reduce backlight intensity for saving power consumption of the LCD and to increase code values of the LCD simultaneously for maintaining brightness or reaching the brightness set by the system without any visible difference. The above solution can maintain or even improve the image quality. The code value can be expressed in 0 to 255. The code value is defined as a light-transmittance parameter obtained by controlling an electric field to determine rotating angles of liquid crystals of the LCD. Accordingly, the backlight passes through the liquid crystals with certain rotating angles to form the brightness of the pixels. A fully-on code value means that the angle of the liquid crystal is fully open so as to provide a highest light-transmittance rate for the display panel.

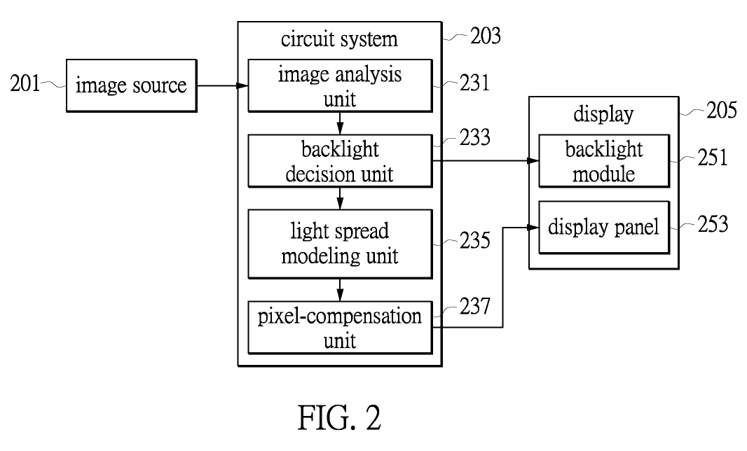

According to one embodiment of the method for modulating the liquid crystal display, the method is operated in the circuit system of a display system. The circuit system can be implemented by a circuitry or firmware. The circuit system is such as a system on chip (SoC) disposed in the display system. Reference is made to FIG. 2, which is a schematic diagram illustrating a system framework of a circuit system 203 and element blocks of a display 205 according to one embodiment of the present disclosure.

The circuit system 203 shown in FIG. 2 is used to operate the method for modulating the liquid crystal display of the present disclosure. The circuit system 203 can be a system on chip (SoC) disposed inside the LCD (e.g., a display 205) or in a video device (e.g., STB) that is externally connected with the display 205.

The circuit system 203 receives image data from an image source 201. The display 205 includes a backlight module 251 and a display panel 253. The method for modulating the LCD is operated in the circuit system 203 for outputting control signals to respectively drive the backlight module 251 and the display panel 253 of the display 205. Further, the circuit system 203 implements an image analysis unit 231, a backlight decision unit 233, a light spread modeling unit 235 and a pixel-compensation unit 237 through collaboration of software and/or firmware.

Before the circuit system 203 performs the method for modulating the liquid crystal display, a power consumption of the display 205 is measured. The measurement of the power consumption of the display 205 obtains, when the code values are fixed, an overall power consumption of the backlight module of the display 205 being adjusted from a lowest brightness to a highest brightness that is measured. On the other hand, when the brightness generated by the backlight module of the display 205 is configured to be fixed, another overall power consumption of the display panel 253 being adjusted from the lowest code values to the highest code values is measured. Thus, adjustments of the code values have almost no impact on the overall power consumption of display 205 that mostly comes from the backlight module. In the meantime, the code values with relatively low power consumption and the brightness value of the backlight module can be obtained.

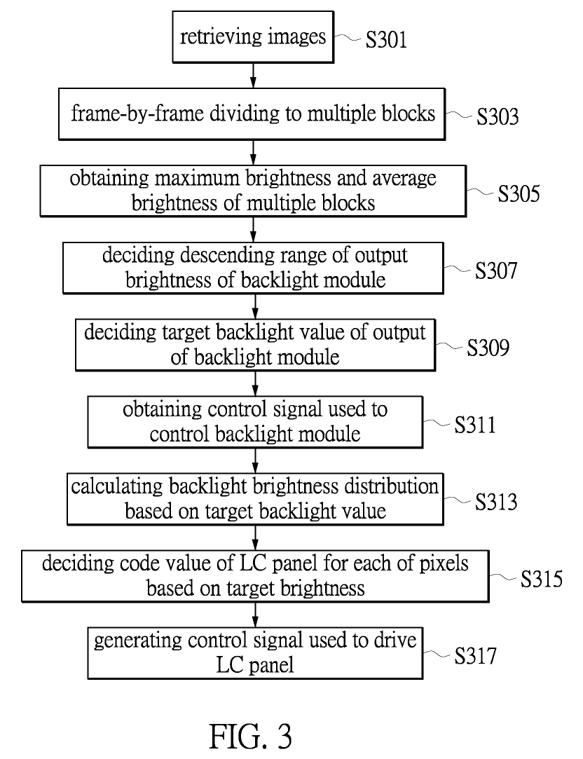

One of the objectives of the method for modulating liquid crystal display operated in the circuit system 203 is to reduce the brightness of the backlight module for saving power consumption, but, in the meantime, to increase code values of the display panel for maintaining the original brightness of the display or to meet the brightness set by the system. Therefore, the display quality can still be guaranteed when the purpose of power saving can be achieved. Reference is also made to FIG. 3, which is a flowchart illustrating the method for modulating the liquid crystal display according to one embodiment of the present disclosure.

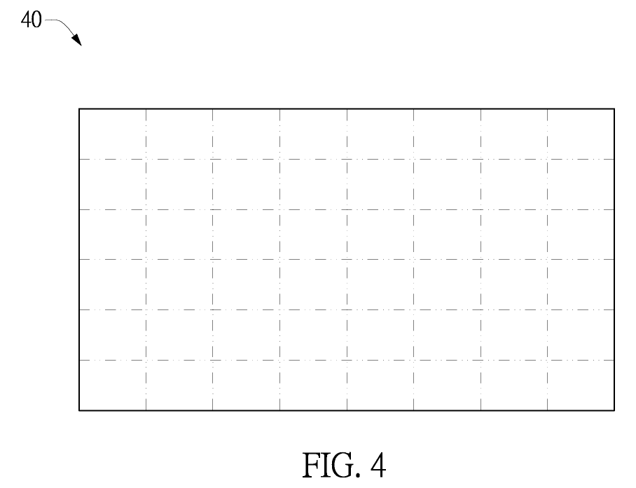

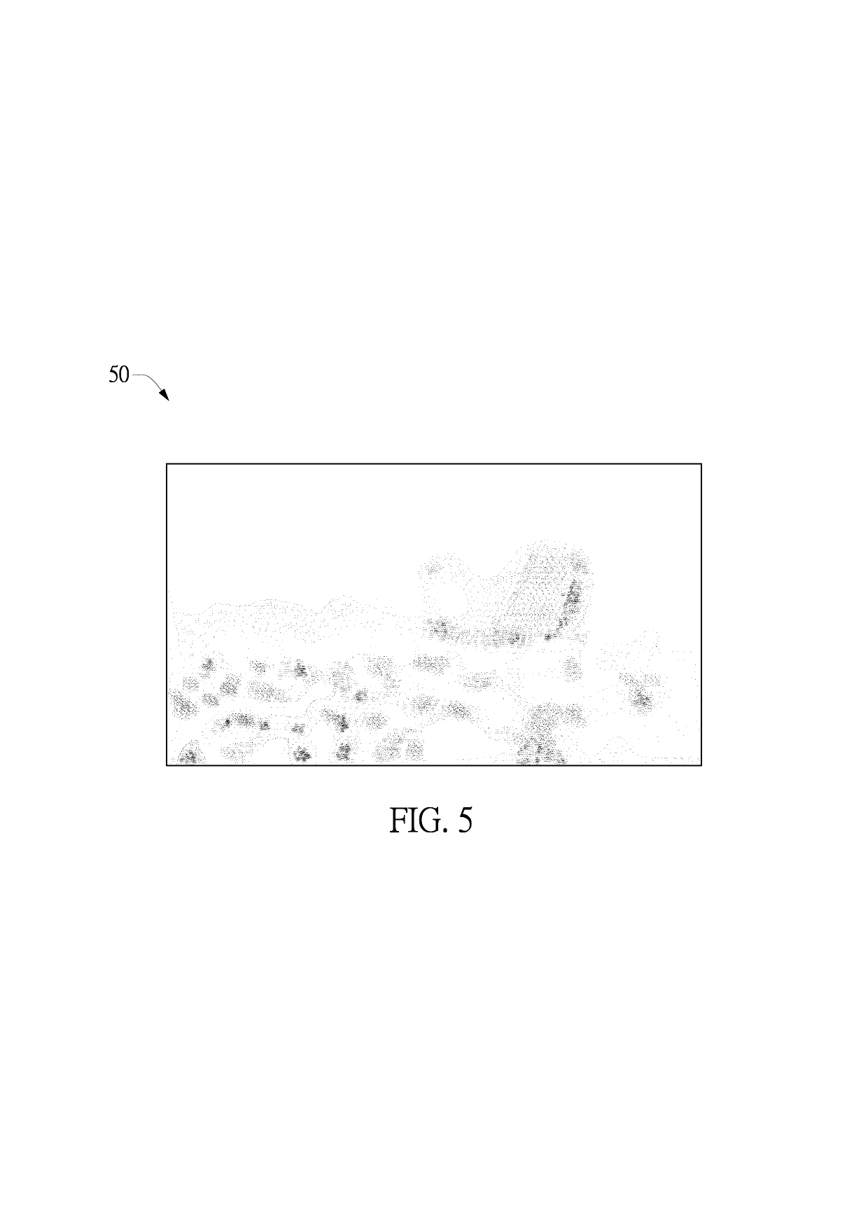

The circuit system 203 operates the method for modulating liquid crystal display. When the circuit system 203 receives imaged data from the image source 201. Each of the frames is divided into multiple blocks, as referring to a schematic diagram shown in FIG. 4. When the image data of the frame is line-by-line received by the circuit system 203, the brightness that the multiple blocks should be can be acknowledged. The color channel values (e.g., R, G, B color channel values) of each of the pixels are referred to for calculating an average brightness of each of the blocks so as to obtain a brightness distribution for the whole frame image. Reference is made to FIG. 5, which schematically shows a brightness distribution diagram of a whole frame in one embodiment of the present disclosure.

In FIG. 3, before the process is in operation, characteristics of the backlight module and the LC panel of the display are firstly obtained. For example, the circuit system 203 can retrieve the characteristics of the backlight module 251 and the display panel 253 of the display 205 based on a connection protocol (e.g., HDMI) connecting with the display 205. In an aspect, for example, the pixel-compensation unit 237 is connected with the display panel 253 over an HDMI connection, and the backlight decision unit 233 can be communicated with the backlight module 251 by a specific communication protocol, e.g., a serial peripheral interface (SPI). The characteristics are such as a type (i.e., a local dimming type or a global dimming type) of the backlight module 251, the code values that indicate rotating angles of liquid crystal molecules of the display panel 253 and a corresponding light-transmittance level.

In the process of the method for modulating liquid crystal display of the present disclosure, the circuit system 203 receives image data from the image source 201 (step S301), and the circuit system 203 processes the imaged data by the image analysis unit 231 for retrieving pixel values of each of the frames in the continuous images. Brightness values are then calculated based on the color (e.g., Red, Green and Blue) channel values of the pixels. The image data can be frame-by-frame divided into multiple blocks. Reference is made to FIG. 4, which is a schematic diagram depicting that a frame 40 is divided into multiple blocks (step S303).

In the embodiment, the image analysis unit 231 performs image analysis while the circuit system 203 retrieves the multiple blocks of each of the frames. It should be noted that the method for dividing the frame into the multiple blocks is determined based on the configuration of the backlight module 251. For example, when the backlight module 251 is a local dimming type of backlight, the quantity of the multiple blocks to be divided frame-by-frame is configured to be the same with the quantity of the local regions of the local dimming type of the backlight module 251; and, when the backlight module 251 is a global dimming type of backlight, the frame is divided into a preset fixed quantity of blocks, e.g., 64 blocks.

Further, an overall backlight intensity is determined according to the code values and the brightness value of the backlight module. When the backlight module 251 is the local dimming type of backlight, the brightness values of the pixels of each of the blocks are calculated to obtain a brightness coverage ratio (e.g., 90%) of the block. The brightness value of the brightness coverage ratio is used as a target brightness value for determining the brightness value of the backlight module. The code values for the display panel 253 are used to compensate insufficient brightness. One of the objectives of the above-mentioned aspect is to exclude a few extreme code values (e.g., a few bright spots) that may increase the power consumption. When the backlight module 251 is the global dimming type of backlight, the backlight module 251 can overall provide a single brightness, which is such as a brightness value being determined according to a target brightness that is determined based on a brightness coverage ratio of the multiple blocks (e.g., 64 blocks). It should be noted that t he higher the brightness coverage ratio is, the higher a relative power saving ratio is.

Based on the multiple blocks, the circuit system 203 analyzes the image data by the software or firmware implemented image analysis unit 231 for obtaining a statistical distribution of the frame image (step S303). For example, a maximum code value of each of the blocks can be obtained and a maximum brightness and an overall average brightness of each of the blocks can be calculated based on the pixel values (e.g., the Red, Green and Blue pixel values) (step S305). Next, the following process can be separated into two phases. The processes of the two phases are not limited to being performed according to the following flows.

In a first phase, the circuit system 203 sets up a backlight operating strategy, and the backlight decision unit 233 performs the first phase operation based on the backlight operating strategy. Since it is not necessary for the backlight module 251 of the display 205 to meet the requirement of the few bright spots when outputting brightness for each of the frames, the backlight decision unit 233 can determine a descending range of an intensity of the outputted brightness (i.e., an output power corresponding to the outputted brightness) based on an actual requirement for displaying the images while considering the above-described maximum brightness and the average brightness of each of the blocks (step S307).

Moreover, a policy for determining the intensity of the outputted brightness of the backlight module 251 can be based on a decision of the backlight brightness coverage ratio. The backlight decision unit 233 relies on the policy to determine a target backlight value that the backlight module 251 should output (step S309). When the backlight module 251 of the display 205 is a local dimming type of backlight, the backlight brightness coverage ratio is referred to for determining the target backlight value. When the backlight module 251 is a global dimming type of backlight, an average of backlight brightness coverage ratios in multiple blocks is referred to for determining the target backlight value. Thus, a control signal used to drive each of the blocks of the backlight module 251 to illuminate is generated by the backlight decision unit 233 based on the target backlight value (step S311).

In a second phase, a policy to determine code values for the LC panel is provided. A set of code values for the display panel 253 can be obtained based on the target brightness set by the circuit system 203 and the target backlight value being determined in step S309. According to certain embodiments of the present disclosure, when the code values for the display panel 253 are determined, the light spread modeling unit 235 of the circuit system 203 uses a light spread modeling method to calculate a brightness value according to the target backlight value determined in the first phase, and to map the brightness for each of the color channel values of the pixels. A backlight brightness distribution of each of the blocks in each of the frames can be obtained (step S313).

Reference is next made to FIG. 5, which is a schematic diagram of a light spread diagram 50 that can be obtained based on the backlight brightness distribution of each of the frames by the light spread modeling unit 235. The light spread diagram 50 schematically depicts a result of an overall brightness distribution that is established by accumulated brightness values of the pixels in each of the blocks of a frame, and the brightness values are obtained by the light spread modeling method.

Afterwards, according to the target brightness and the backlight brightness distribution for the multiple blocks, the code value corresponding to each of the pixels in each of the blocks that can reach the target brightness is obtained. The pixel-compensation unit 237 of the circuit system 203 obtains the code values for the LC panel for compensating the brightness of each of the pixels for reaching the target brightness of each of the blocks of the display panel 253 (step S315). Finally, the circuit system 203 generates a second control signal used to drive the display panel 253 according to the code values of the LC panel (step S317). Thus, the backlight module 251 and the display panel 253 of the display 205 are respectively driven to operate by the first control signal and the second control signal generated by the circuit system 20.

It should be noted that every LCD has its own characteristics such as a Gamma curve that is used to express a light-transmittance rate of a display panel. For reducing backlight brightness, it is necessary to compensate the brightness by the code values that are used to control the light-transmittance rate by controlling the rotating angles of the LC molecules. Thus, in the method for modulating liquid crystal display, the code values can be calculated based on the brightness that each of the blocks in each frame should be and the backlight brightness value obtained for saving power for each of the blocks. Accordingly, the circuit system relies on the code values to control the rotating angles of LC molecules in each of the blocks of the LCD.

In subsequent applications, the light spread modeling method can be used to obtain the brightness values and the brightness distribution of the pixels based on the backlight brightness value, so as to determine the code values of the LC panel for reaching the target brightness and calculate the compensation value for each of the blocks. For example, a display panel outputs code values with 200 nits, and the code values are compensated for the LC panel to output 400 nits if the output of the backlight module is reduced by two times.

Further, when a local dimming method or a global dimming method is applied to the backlight module of the display, a target backlight value for each of the blocks is determined according to a backlight brightness coverage ratio. If the backlight brightness coverage ratio is low, the display may not reach the target brightness. Therefore, in the method for modulating the liquid crystal display, a Sigmoid function is introduced to process the code value, and the code values of the display panel can be converted to values between 0 and 1. When an inputted code value is very large, the code value will be close to 1 when the code value is processed by the Sigmoid function. When the inputted code value is, but not limited to, a large negative number, the code value of the display panel will be close to 0. A Sigmoid function is introduced to process the code value corresponding to each of the pixels in blocks. Accordingly, not only can oversaturation of the image be avoided, but contrast of the image can also be increased by adjusting an S-curve of the code value when there are only a few bright spots in the blocks. The circuit system defines the backlight brightness coverage ratio “90%” since the backlight brightness coverage ratio is generally low.

In conclusion, one of the objectives of the method for modulating a liquid crystal display and the circuit system for operating the method in the above embodiments is to maintain the display quality without compromising the visual effect even though the power consumption of the backlight module of the display is required to be reduced. The main technical concept of the method is to calculate code values used to compensate the brightness when the backlight brightness is reduced through an algorithm operated in the circuit system of the display. Therefore, the purpose of power saving for the LCD can be achieved when the intensity of backlight is reduced and the target brightness can still be maintained by increasing the light-transmittance rate of the LC panel.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. A method for modulating a liquid crystal display, operated in a circuit system of a display, comprising:
receiving image data and frame-by-frame dividing each of frames into multiple blocks;
frame-by-frame analyzing the image data, and obtaining a maximum brightness and an average brightness of each of the blocks according to pixel values of the blocks;
determining a target backlight value of a backlight module of the display according to the maximum brightness and the average brightness of each of the blocks;
generating a first control signal used to drive the backlight module according to the target backlight value of each of the blocks or a global area of the backlight module;
obtaining a set of code values of a display panel of the display according to a target brightness set by the circuit system and the target backlight value of the backlight module; and
determining a code value for each of pixels in each of blocks for reaching the target brightness, and the circuit system generating a second control signal for driving the display panel according to the code value of each of the pixels.

2. The method according to claim 1, wherein a Sigmoid function is used to process the code value corresponding to each of the pixels and increase image contrast by adjusting an S-curve of the code value in blocks.

3. The method according to claim 1, wherein, when color channel values of each of the pixels are frame-by-frame retrieved from the image data, the maximum brightness and the average brightness of each of the blocks is calculated.

4. The method according to claim 1, wherein, when the backlight module of the display is a local dimming type of backlight, a quantity of the multiple blocks that are frame-by-frame divided is equal to a quantity of local regions of the backlight module; when the backlight module is a global dimming type of backlight, the image data is frame-by-frame divided into a fixed quantity of the multiple blocks.

5. The method according to claim 4, wherein, when the backlight module is the local dimming type of backlight, a brightness value of a brightness coverage ratio of each of the multiple blocks is used as a target backlight value to determine a backlight value of the backlight; when the backlight module is a global dimming type of backlight, a brightness value of an average brightness coverage ratio of a fixed quantity of the multiple blocks is used as the target backlight value to determine the backlight value of the backlight.

6. The method according to claim 5, wherein, when the set of code values of the display panel are determined, the circuit system operates a light spread modeling method that calculates a brightness value of each of the pixels in each of the blocks corresponding to the backlight brightness value according to the target backlight value and obtains a backlight brightness distribution of each of the blocks in each of the frames.

7. The method according to claim 6, wherein the code value of each of the pixels in each of the blocks for reaching the target brightness is determined according to the target brightness and the backlight brightness distribution of each of the blocks.

8. The method according to claim 7, wherein a Sigmoid function is used to process the code value corresponding to each of the pixels and increase image contrast by adjusting an S-curve of the code value in blocks.

9. A circuit system, electrically connected with a backlight module and a display panel of a display, wherein the circuit system performs a method for modulating a liquid crystal display comprising:
receiving image data and frame-by-frame dividing each of frames into multiple blocks;
frame-by-frame analyzing the image data, and obtaining a maximum brightness and an average brightness of each of the blocks according to pixel values of the blocks;
determining a target backlight value of the backlight module of the display according to the maximum brightness and the average brightness of each of the blocks;
generating a first control signal used to drive the backlight module according to the target backlight value of each of the blocks or a global area of the backlight module;
obtaining a set of code values of the display panel of the display according to a target brightness set by the circuit system and the target backlight value of the backlight module; and
determining a code value for each of pixels in each of blocks for reaching the target brightness, and the circuit system generating a second control signal for driving the display panel according to the code value of each of the pixels.

10. The circuit system according to claim 9, wherein a Sigmoid function is used to process the code value corresponding to each of the pixels and increase image contrast by adjusting an S-curve of the code value in blocks.

11. The circuit system according to claim 9, wherein the circuit system is disposed in a display or a video device, and the circuit system receives the image data from an image source and operates the method for modulating the liquid crystal display for outputting the first control signal and the second control signal to respectively drive the backlight module and the display panel of the display.

12. The circuit system according to claim 9, wherein, when the backlight module of the display is a local dimming type of backlight, a quantity of the multiple blocks that are frame-by-frame divided is equal to a quantity of local regions of the backlight module; when the backlight module is a global dimming type of backlight, the image data is frame-by-frame divided into a fixed quantity of the multiple blocks.

13. The circuit system according to claim 12, wherein, when the backlight module is the local dimming type of backlight, a brightness value of a brightness coverage ratio of each of the multiple blocks is used as a target to determine a backlight value of the backlight; when the backlight module is a global dimming type of backlight, a brightness value of an average brightness coverage ratio of a fixed quantity of the multiple blocks is used as the target to determine the backlight value of the backlight.

14. The circuit system according to claim 13, wherein, when the set of code values of the display panel are determined, the circuit system operates a light spread modeling method to calculate the brightness value of each of the pixels in each of the blocks corresponding to the backlight brightness according to the target backlight value.

15. The circuit system according to claim 14, wherein the code value of each of the pixels in each of the blocks for reaching the target brightness is determined according to the target brightness and the backlight brightness distribution of each of the blocks.

16. The circuit system according to claim 15, wherein a Sigmoid function is used to process the code value corresponding to each of the pixels and increase image contrast by adjusting an S-curve of the code value in blocks.
